(19) United States
(12) Patent Application Publication
(10) Pub. No.: US 2024/0393955 A1
(43) Pub. Date: Nov. 28, 2024

(54) COLLABORATIVE CACHING EXPLOITING NEAR-STORAGE MEMORY

(71) Applicants: Samsung Electronics Co., Ltd., Suwon-si (KR); RUTGERS, THE STATE UNIVERSITY OF NEW JERSEY, New Brunswick, NJ (US)

(72) Inventors: Marie Mai NGUYEN, Pittsburgh, PA (US); Jian ZHANG, Piscataway, NJ (US); Sudarsun KANNAN, Rahway, NJ (US); Yujie REN, Piscataway, NJ (US); Chang Woo MIN, Blacksburg, VA (US)

(21) Appl. No.: 18/668,063

(22) Filed: May 17, 2024

Related U.S. Application Data
(60) Provisional application No. 63/601,197, filed on Nov. 20, 2023.
(60) Provisional application No. 63/469,364, filed on May 26, 2023.

(51) Int. Cl. G06F 3/06; G06F 12/0811

(52) U.S. Cl. CPC G06F 3/0613; G06F 3/0659; G06F 3/0679; G06F 12/0811; G06F 2212/222

(57) ABSTRACT

A system is disclosed. The system may include a processor, a first memory connected to the processor, and a second memory connected to the processor. A data structure may include an entry, which may identify that a data is stored in a location. The location may include one of the first memory or the second memory.

### RELATED APPLICATION DATA

This application claims the benefit of U.S. Provisional Patent Application Ser. No. 63/601,197, filed Nov. 20, 2023, and U.S. Provisional Patent Application Ser. No. 63/469,364, filed May 26, 2023, both of which are incorporated by reference herein for all purposes.

### FIELD

The disclosure relates generally to memory and storage, and more particularly to improving response time in accessing memory.

### BACKGROUND

Memory systems in computers continue to evolve and become more complex. Managing data as it transits between layers in the memory system is therefore also increasing in complexity Mismanagement of where data is currently stored may lead to delays in returning data to an application.

A need remains to support faster data access.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 shows a machine including a memory device to access data from various memories, according to embodiments of the disclosure.

FIG. 2 shows details of the machine of FIG. 1, according to embodiments of the disclosure.

FIG. 3 shows how the machine of FIG. 1 may access a data from various memories, according to embodiments of the disclosure.

FIG. 4A shows a first example arrangement of the accelerator of FIG. 1 that may be associated with the storage device of FIG. 1, according to embodiments of the disclosure.

FIG. 4B shows a second example arrangement of the accelerator of FIG. 1 that may be associated with the storage device of FIG. 1, according to embodiments of the disclosure.

FIG. 4C shows a third example arrangement of the accelerator of FIG. 1 that may be associated with the storage device of FIG. 1, according to embodiments of the disclosure.

FIG. 4D shows a fourth example arrangement of the accelerator of FIG. 1 that may be associated with the storage device of FIG. 1, according to embodiments of the disclosure.

FIG. 5 shows details of the storage device of FIG. 1, according to embodiments of the disclosure.

FIG. 6A shows a first example of the data structure of FIG. 3 used to manage where data is stored in various memories, according to embodiments of the disclosure.

FIG. 6B shows a second example of the data structure of FIG. 3 used to manage where data is stored in various memories, according to embodiments of the disclosure.

FIG. 7 shows details of the analysis engine of FIG. 3, according to embodiments of the disclosure.

FIG. 8 shows details of the calculator of FIG. 7, according to embodiments of the disclosure.

FIG. 9 shows a flowchart of an example procedure for the machine of FIG. 1 to process the data access request of FIG. 3, according to embodiments of the disclosure.

FIG. 10 shows a flowchart of an example procedure for the machine of FIG. 1 to receive the data access request of FIG. 3, according to embodiments of the disclosure.

FIG. 11 shows a flowchart of an example procedure for the machine of FIG. 1 to lock and unlock access to data in the various memories, according to embodiments of the disclosure.

FIG. 12 shows a flowchart of an example procedure for the machine of FIG. 1 to process the processing request of FIG. 3, according to embodiments of the disclosure.

FIG. 13 shows a flowchart of an example procedure for the machine of FIG. 1 to receive the processing request of FIG. 3, according to embodiments of the disclosure.

FIG. 14A shows a flowchart of an example procedure for the machine of FIG. 1 to determine where to process the processing request of FIG. 3, according to embodiments of the disclosure.

FIG. 14B continues the flowchart of FIG. 14A of an example procedure for the machine of FIG. 1 to determine where to process the processing request of FIG. 3, according to embodiments of the disclosure.

### SUMMARY

A machine may include a data structure that may track where individual data elements are currently stored. The machine may use the data structure to expedite access a particular data element.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Initially, computers included only two layers of storage: main memory and the tape drive or hard disk drive (a storage device). The application could keep track of what data was currently in main memory or not, and could therefore access the data directly from either the main memory of the storage device.

But as computers have grown in complexity, so have the memory systems they use. Now, a host processor may include multiple layers of cache, which may function as a faster access point, even than main memory, for frequently used data. Storage devices have also evolved to include local memory. Even Solid State Drives (SSDs), which are faster than hard disk drives, may benefit from the use of memory such as Dynamic Random Access Memory (DRAM), which may be faster still than flash memory. SSDs may therefore use DRAM or other memory local to the device as a cache for data from the flash memory, much like the releasing the lock to the entry in the data structure for use by the thread may cache data stored in main memory.

Some SSDs even support direct access to device local memory by the processor and the application. For example, cache-coherent interconnect protocols, such as the Compute Express Link® (CXL®) protocol, may permit the processor to access data from both the device local memory and the flash memory. (Compute Express Link and CXL are registered trademarks of the Compute Express Link Consortium in the United States.) The device local memory may therefore act as an alternative to main memory, in terms of accessibility from the processor.

In all, it is not uncommon for a computer system to have 6 or more different layers where data might be stored: for example, three layers of processor cache, main memory, device local memory, and device persistent storage. There may also be multiple instances of elements at a particular layer: for example, if a computer system has three SSDs, each with flash memory and device local memory, then there are three device local memories and three device persistent storages where data might be stored.

The conventional paradigm for accessing data is to query the processor caches to see if the data is present therein. If not, then the main memory may be checked to see if it stores the data, then the device local memory, and finally in the device persistent storage. (The latter two checks may be performed by the controller of the device rather than by the processor, but the accessing of the layers in sequence is effectively the same.) If the data is ultimately found only in the device persistent storage, the checks for the data in the processor caches, main memory, and device local memory add delay to the return of the data: this delay, while not necessarily large on a per access basis, may become significant when multiplied by the number of data accesses the processor might perform over time.

Embodiments of the disclosure address this problem by offering a different paradigm for accessing data. A data structure, such as a scalable interval tree, may be used to track where portions of a particular file may be stored. Each node in the data structure may specify the location for a given portion of the file. A data access request by an application may be intercepted. The data structure may be identified and the node located based on the data being requested. The node may indicate where the data is currently stored: processor cache, main memory, device cache, or persistent storage. The data may then be accessed directly from where the data is actually stored and returned to the application, avoiding multiple data accesses to various layers of the memory system.

If the data is stored in multiple locations—for example, in both device local memory and device persistent storage—the data may be accessed from the faster location: in this example, device local memory. In some embodiments of the disclosure, the data may be stored in multiple locations not counting the device persistent storage; in other embodiments of the disclosure, the data may be stored in only one location other than the device persistent storage. Thus, if the data is stored in the processor cache after access, the data may be removed from the device local memory.

Each node in the data structure may also act as a lock on the data represented by that node. Different nodes, even in the same data structure, may be locked by different threads. Thus, the data structure may support multi-threaded access. The number of threads that may simultaneously access the data structure is theoretically unbounded (although in practice, the number of threads the processor may support may function as an upper bound on the number of threads that may access the data structure simultaneously).

The data structure itself may be relatively small: perhaps 0.0005% of the size of the original file. This means that a one terabyte (TB) file may be represented by a data structure approximately only 32 megabytes (MB) in size.

As data is added to or evicted from various layers in the memory system, the data structure may be updated. Thus, when the processor stores or evicts data from the processor cache, the processor may inform the data structure so that the data structure may be updated. The device may similarly notify the data structure when data is added to or evicted from the device cache.

Embodiments of the disclosure may also support management of computational processing resources. If a device supports computational processing—for example, the device includes an accelerator or other processor—a function may check the data structure to see where the data is currently resident. If the data is entirely in the processor cache, then the processor may perform the requested processing. If the data is entirely on the device and the device is capable of performing the processing, then the processing may be shifted to the device. And if the data is split between the processor cache, the system may perform an analysis to determine whether it is more efficient for the host processor, the device processor, or a combination of the two to perform the processing.

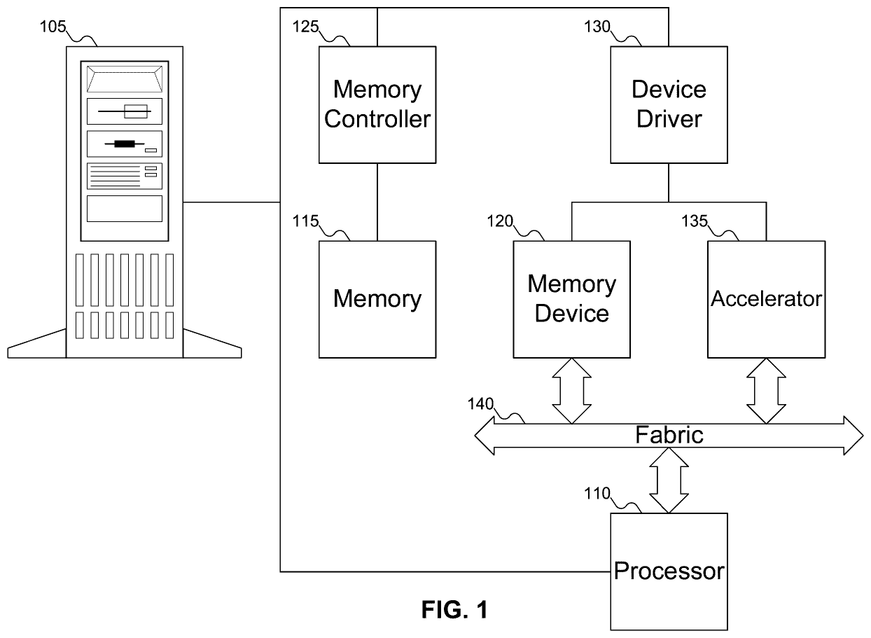

FIG. 1 shows a machine designed to access data from various memories, according to embodiments of the disclosure. In FIG. 1, machine 105, which may also be termed a host or a system, may include processor 110, memory 115, and memory device 120.

Processor 110 may be any variety of processor. (Processor 110, along with the other components discussed below, are shown outside the machine for case of illustration:

embodiments of the disclosure may include these components within the machine.) While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115, which may also be referred to as a main memory, may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or memory device 120. Memory device 120 may be accessed using device driver 130.

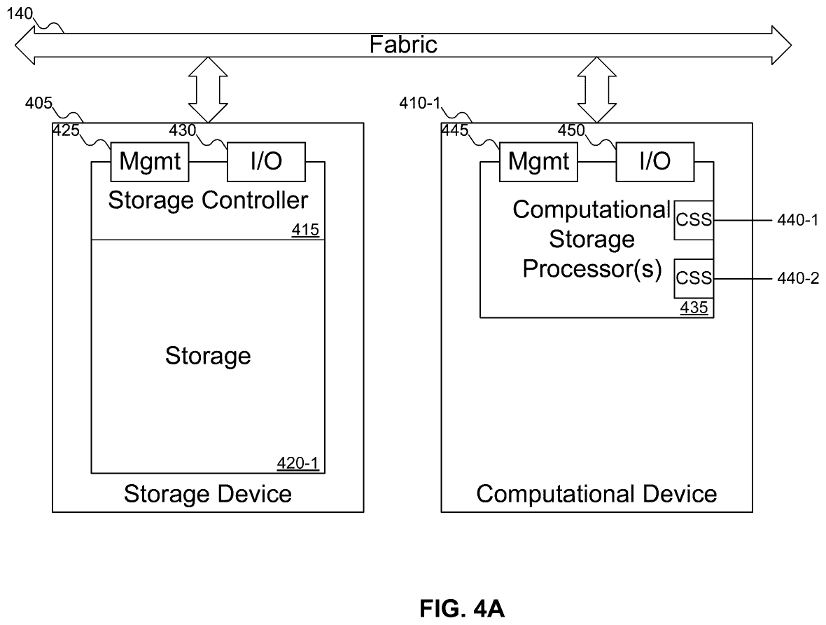

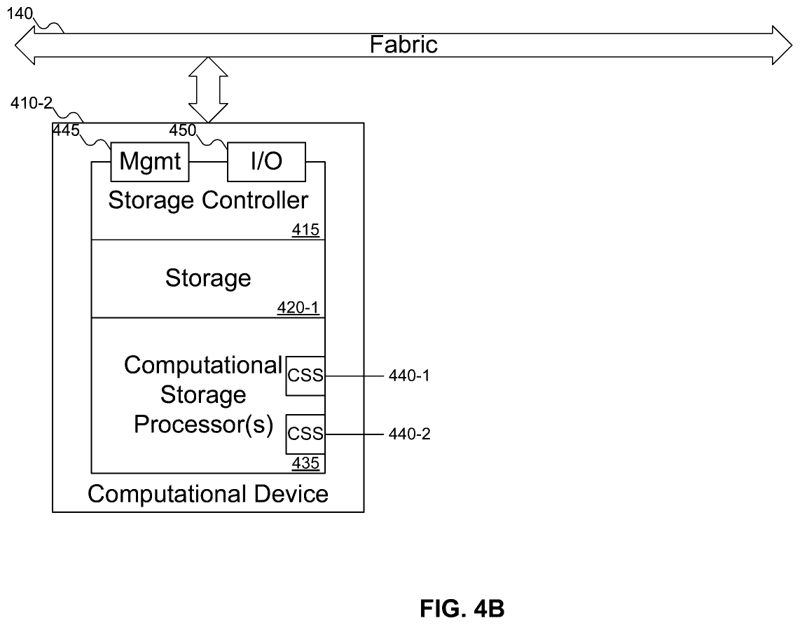

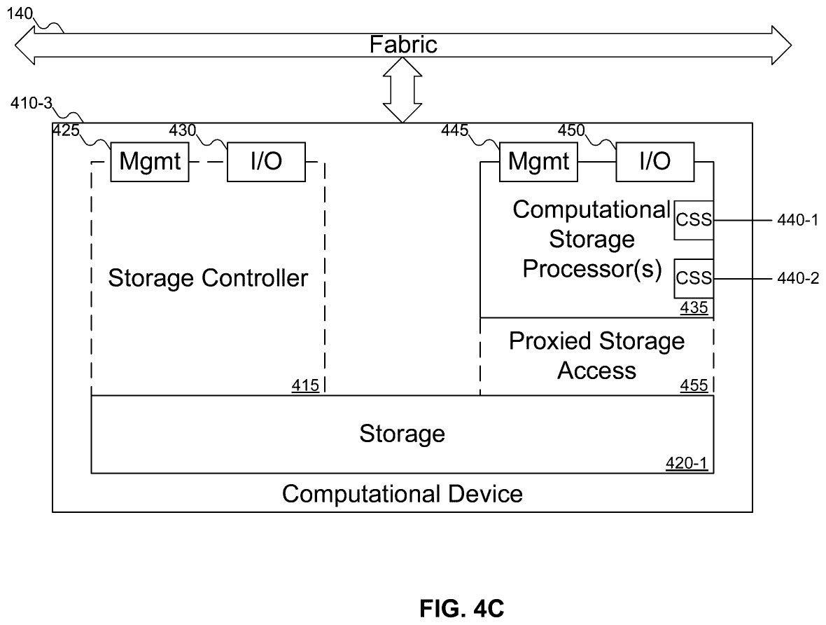

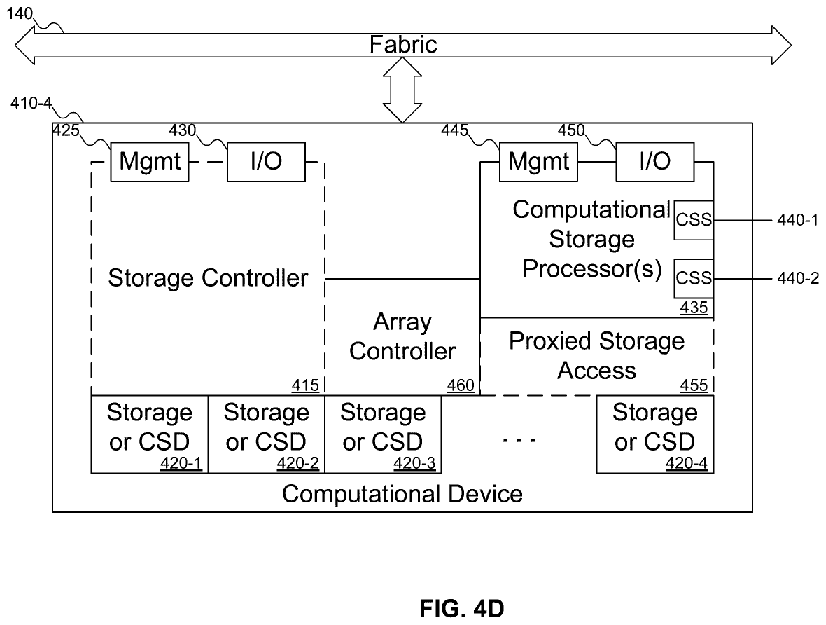

Memory device 120 may be associated with accelerator 135, which may also be referred to as a computational storage device, computational storage unit, computational memory device, or computational device. As discussed with reference to FIGS. 4A-4D below, memory device 120 and accelerator 135 may be designed and manufactured as a single integrated unit, or accelerator 135 may be separate from memory device 120. The phrase “associated with” is intended to cover both a single integrated unit including both a memory device and an accelerator and a memory device that is paired with an accelerator but that are not manufactured as a single integrated unit. In other words, a memory device and an accelerator may be said to be “paired” when they are physically separate devices but are connected in a manner that enables them to communicate with each other. Further, in the remainder of this document, any reference to memory device 120 and/or accelerator 135 may be understood to refer to the devices either as physically separate but paired (and therefore may include the other device) or to both devices integrated into a single component as a computational storage unit.

In addition, the connection between the memory device and the paired accelerator might enable the two devices to communicate, but might not enable one (or both) devices to work with a different partner: that is, the memory device might not be able to communicate with another accelerator, and/or the accelerator might not be able to communicate with another memory device. For example, the memory device and the paired accelerator might be connected serially (in either order) to the fabric, enabling the accelerator to access information from the memory device in a manner another accelerator might not be able to achieve. Note that accelerator 135 is optional, and may be omitted in some embodiments of the disclosure.

While FIG. 1 uses the generic term “memory device”, embodiments of the disclosure may include any memory device formats that may be associated with computational storage, examples of which may include hard disk drives and Solid State Drives (SSDs). Any reference to a specific type of memory device, such as an “SSD”, below should be understood to include such other embodiments of the disclosure.

Processor 105, memory device 120, and accelerator 135 are shown as connecting to fabric 140. Fabric 140 is intended to represent any fabric along which information may be passed. Fabric 140 may include fabrics that may be internal to machine 105, and which may use interfaces such as Peripheral Component Interconnect Express (PCIe), Serial AT Attachment (SATA), or Small Computer Systems Interface (SCSI), among others. Fabric 140 may also include fabrics that may be external to machine 105, and which may use interfaces such as Ethernet, Infiniband, or Fibre Channel, among others. In addition, fabric 140 may support one or more protocols, such as Non-Volatile Memory Express (NVMe), NVMe over Fabrics (NVMe-oF), Simple Service Discovery Protocol (SSDP), or a cache-coherent interconnect protocol, such as the Compute Express Link® (CXL®) protocol, among others. (Compute Express Link and CXL are registered trademarks of the Compute Express Link Consortium in the United States.) Thus, fabric 140 may be thought of as encompassing both internal and external networking connections, over which commands may be sent, either directly or indirectly, to memory device 120 (and more particularly, accelerator 135 associated with memory device 120). In embodiments of the disclosure where fabric 140 supports external networking connections, memory device 120 and/or accelerator 135 might be located external to machine 105.

FIG. 1 shows processor 105, memory device 120, and accelerator 135 as being connected to fabric 140 because processor 105, memory device 120, and accelerator 135 may communicate via fabric 140. In some embodiments of the disclosure, memory device 120 and/or accelerator 135 may include a connection to fabric 120 that may include the ability to communicate with a remote machine and/or a network: for example, a network-capable Solid State Drive (SSD). But in other embodiments of the disclosure, while machine 105 may include a connection to another machine and/or a network (which connection may be considered part of fabric 140), memory device 120 and/or accelerator 135 might not be connected to another machine and/or network. In such embodiments of the disclosure, memory device 120 and/or accelerator 135 may still be reachable from a remote machine, but such commands may pass through processor 110, among other possibilities, to reach memory device 120 and/or accelerator 135.

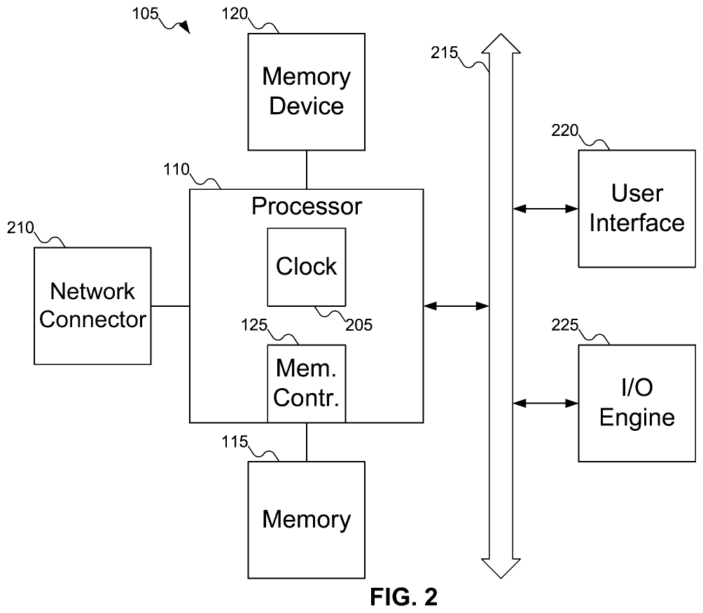

FIG. 2 shows details of the machine of FIG. 1, according to embodiments of the disclosure. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to memory devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components.

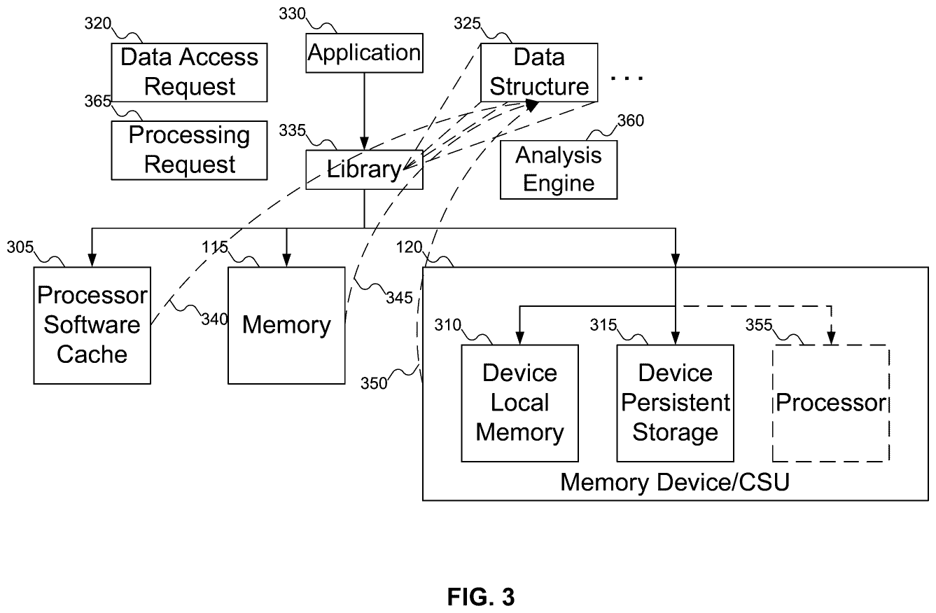

FIG. 3 shows how machine 105 of FIG. 1 may access a data from various memories, according to embodiments of the disclosure. In FIG. 3, machine 105 of FIG. 1 may include various different memories. These may include, for example, processor software cache 305 (which may be within processor 110 of FIG. 1 or a cache within memory 115), memory 115, and memory device 120.

Processor software cache 305 may include a cache that is local to processor 110 of FIG. 1. Processor software cache 305 may be representative of any number of processor caches that might be included in processor 110 of FIG. 1. For example, processor 110 of FIG. 1 may include an L1, an L2, and an L3 cache, each of which may offer different responsiveness and capacities: data may be moved between the various levels of processor software cache 305 as processor 110 of FIG. 1 considers appropriate. Note that in some embodiments of the disclosure, processor software cache 305 might be external to processor 110 of FIG. 1: for example, a DRAM cache in memory 115 or close to memory 115.

Memory device 120 itself may include device local memory 310 (which may also be referred to as a device memory or device cache) and device persistent storage 315 (which may be referred to as device storage). In some embodiments of the disclosure, device local memory 310 may include flash memory, DRAM, SRAM, Persistent Random Access Memory, FRAM, or NVRAM, such as MRAM, whereas device persistent storage 315 may include disk platters as might be found in a hard disk drive or flash memory as might be found in an SSD. Device local memory 310 may be a variety of volatile memory, whereas device persistent storage 315 may be a variety of non-volatile memory.

In some embodiments of the disclosure, device local memory 310 may act as a cache for data otherwise stored in device persistent storage 315. That is, when data is read from memory device 120, the data may first be loaded from device persistent storage 315 into device local memory 310 and then returned. Similarly, when data is written to memory device 120, the data may be written first to device local memory 310 and then later transferred to device persistent storage 315 for more permanent (persistent) storage.

In some embodiments of the disclosure, memory device 120 may expose an address range consistent with device persistent storage 315, like a storage device (accessible by reading or writing pages, blocks, or sectors, depending on the implementation of device persistent storage 315). In such embodiments of the disclosure, processor 110 of FIG. 1 may issue a data access request, such as a read request or a write request, to memory device 120 using an input/output (I/O) queue or a submission queue. Memory device 120 may then access the data access request from such a queue and may return a result in an appropriate matter: for example, via a completion queue. In other embodiments of the disclosure, memory device 120 may expose an address range as though memory device 120 was another form of memory like memory 115: the address range exposed by memory device 120 in such embodiments of the disclosure may be the same size as or smaller than the capacity of storage offered by device persistent storage 315. In such embodiments of the disclosure, device local memory 310 may be accessible to processor 110 of FIG. 1, much like memory 115 may be accessible to processor 110 of FIG. 1. In yet other embodiments, memory device 120 may support processor 110 of FIG. 1 accessing both device local memory 310 similarly to how memory 115 may be accessed, as well as reading data from and writing data to device persistent storage 315 like a storage device.

In some embodiments of the disclosure, data might be resident in both processor software cache 305 (or memory 115) and in device local memory 310. But in other embodiments of the disclosure, data that is stored in processor software cache 305 (or in memory 115) should not be stored in device local memory 310, and vice versa. That is, data may be stored in exclusively in device local memory 310 or in processor software cache 305/memory 115, not both.

In response to a read or write request, such as data access request 320, processor 110 of FIG. 1 may search the various memories 305, 115, 310, and 315 sequentially to attempt to locate the data. For example, the fastest memory, such as processor software cache 305, may be searched first; if the data is not located in processor software cache 305, then the next fastest memory, such as a DRAM cache may be searched, then memory 115 may be searched, then device local memory 310, and finally device persistent storage 315 may be searched if the data was not found anywhere else. But by searching memories 305, 115, 310, and 315 sequentially, the time required to access data from each memory 115, 310, and 315 in turn becomes cumulative with respect to the times required to search all earlier memories. For example, if the time to access L1, L2, and L3 processor caches 305 are 2 nanoseconds (ns), 10 ns, and 20 ns, respectively, the time to access memory 115 is 60 ns, the time to access device local memory 310 is 400 ns (device local memory 310 might use the same DRAM as memory 115, but is located across a different bus that may increase latency time, as well as some additional time for the controller of memory device 120 to handle the request), and 50 microseconds (μs), by the time memory 115 is searched for the data 32 ns have already passed (2+12+20 for each level of processor software cache 305), which means that 32 ns have elapsed before memory 115 is even accessed to attempt to locate the requested data. This increased time carries over to each memory later in the sequence.

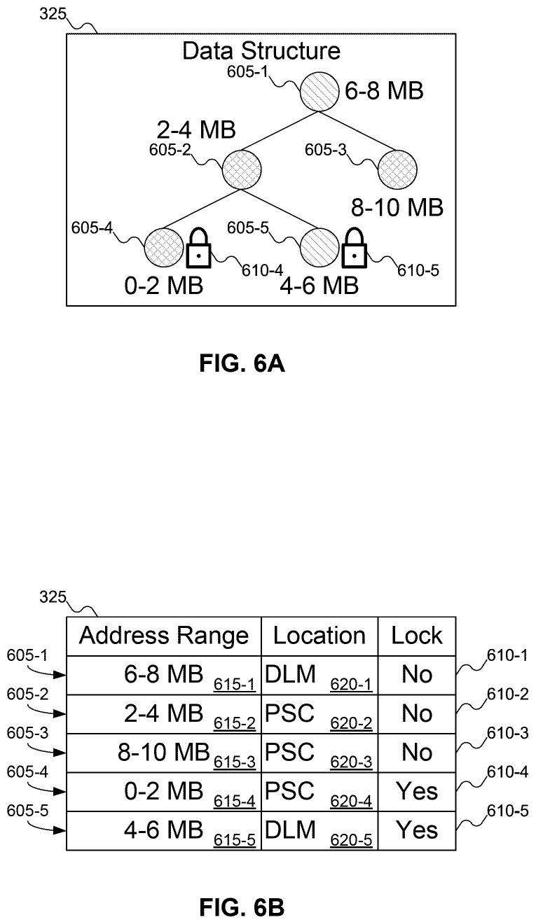

Embodiments of the disclosure avoid this increased delay by using data structure 325. Data structure may specify where the requested data is currently stored: in processor software cache 305, in memory 115, in device local memory 310, or in device persistent storage 315. The data access request may then be sent directly to the memory that stores the data, without incurring additional delays to search other memories. Using data structure 325 may involve a small delay to determine where the data is actually located (or, for data stored in multiple locations, to determine all the locations where the data is stored), but this query may be less than the time required to search each memory individually and sequentially. While the use of data structure 325 may result in slightly slower accesses from processor software cache 305 (or whatever memory would be first in the sequence), typically the first memory in the sequence is the smallest memory in capacity and therefore might have a negative impact on data access time only infrequently: most data accesses will likely be faster. Data structure 325 is discussed further with reference to FIGS. 6A-6B below.

In some embodiments of the disclosure, processor 110 of FIG. 1 may support multi-threaded execution (either multiple threads of an application such as application 330, or threads of multiple applications 330). In such embodiments of the disclosure, machine 105 may be able to support multi-threaded access to data structure 325. Because multi-threaded access may create potential conflicts for different threads attempting to access the same data at the same time, data structure 325 may support locking various parts of the data. Locking of data is discussed further with reference to FIGS. 6A-6B below. In theory, the number of threads that may access data structure 325 is unbounded (aside from any limits imposed by processor 110 of FIG. 1), but in practice, there may be an upper bound (such as 100-200) to the number of threads that may simultaneously access data structure 325 before access to data structure 325 might become relatively slow and a bottleneck of its own.

To use data structure 325, machine 105 of FIG. 1 may implement library 335. Library 335 may be a library of routines that support the use of data structure 325. For example, library 335 may include a function to intercept a data access request. That is, when application 330 issues data access request 320, library 335 may intercept that request before it reaches conventional processing. Library 335 may then determine what data is being accessed in data access request 320, use data structure 325 to determine where that data is currently stored, and then direct data access request 320 to the appropriate memory directly. For example, if the data being accessed may be found in device local memory 310, library 335 may direct data access request 320 to device local memory 310, bypassing any searches of processor software cache 305 or memory 115.

For data structure 325 to be usable, data structure 325 should be updated whenever data is added or evicted from a memory. Thus, when data is added to or evicted from processor software cache 305, memory 115, or memory device 120 (most typically in device local memory 310, but in some embodiments of the disclosure changes to data in device persistent storage 315 may also be reflected in data structure 325), data structure 325 may be updated accordingly. This fact is represented by dashed lines 340, 345, and 350. Processor 110 of FIG. 1 (or more precisely, the kernel of the operating system running on processor 110 of FIG. 1) may notify library 335 about changes to what data is stored therein, so that a function of library 335 may update data structure 325. Similarly, memory device 120 (more precisely, the controller of memory device 120) may notify library 335 about changes to what data is stored where, so that the function of library 335 may update data structure 325.

Application 330 may also issue requests that data be processed using a particular function, which might be known in advance: either a standard function offered by some library (possibly different from library 335) or a custom designed function. While processor 110 of FIG. 1 may be able to execute this function on the identified data, in some embodiments of the disclosure, memory device 120 may include processor 355, which may be a version of accelerator 135 of FIG. 1 (compare FIG. 3, which shows a single computational storage unit including both memories 310 and 315 and processor 355, with FIG. 1, which shows memory device 120 and accelerator 135 of FIG. 1 as paired but separate elements: both arrangements are possible in various embodiments of the disclosure). That is, processor 355 may provide some local processing capability nearer to data on memory device 120 than processor 110 of FIG. 1, and memory device 120 might be a computational storage unit. In such embodiments of the disclosure, it might be more efficient to process the data locally on processor 355 rather than have processor 110 execute the function. For example, if the data is all resident on device persistent storage 315 and is not available in processor software cache 305 or memory 115, having processor 110 of FIG. 1 execute the function might require more time (in moving the data from device persistent storage 315 to memory 115, for example) than having processor 355 execute the function.

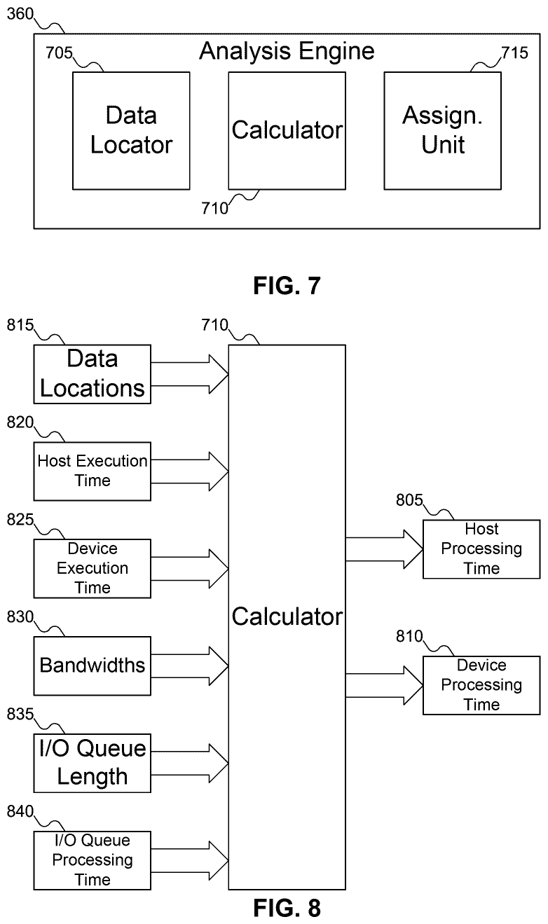

To determine where to have such a function engine, embodiments of the disclosure may include analysis engine 360. Analysis engine 360 may perform a calculation to estimate the time required to execute the function on processor 110 of FIG. 1 versus processor 355, and to dispatch processing request 365 to the appropriate element to execute the requested function. Processing request 365 might be dispatched to processor 110 of FIG. 1, processor 355, or even to both to collaboratively execute the function. Analysis engine 360 is discussed further with reference to FIGS. 7-8 below.

FIGS. 4A-4D show various arrangements of accelerator 135 of FIG. 1 that may be associated with storage device 120 of FIG. 1, according to embodiments of the disclosure. In FIG. 4A, storage device 405 (which may be storage device 120 of FIG. 1) and computational device 410-1 (which may be accelerator 135 of FIG. 1 or processor 355 of FIG. 3, and which may also be referred to as a computational storage unit, a computational storage device, or a device) are shown. Storage device 405 may include controller 415 and storage 420-1. Storage device 405 may be reachable using any desired form of access. For example, in FIG. 4A, storage device 405 may be accessed across fabric 140 using a submission queue and a completion queue, which may form a queue pair. In FIG. 4A, storage device 405 is shown as including two queue pairs: management queue pair 425 may be used for management of storage device 405, and I/O queue pair 430 may be used to control I/O of storage device 405. (Management queue pair 425 and I/O queue pair 430 may be referred to more generally as queue pairs 425 and 430, without reference to their specific usage.) Embodiments of the disclosure may include any number (one or more) of queue pairs 425 and 430 (or other forms of access), and access may be shared: for example, a single queue pair may be used both for management and I/O control of storage device 405 (that is, queue pairs 425 and 430 may be combined in one queue pair).

Computational device 410-1 may be paired with or associated with storage device 405. Computational device 410-1 may include any number (one or more) processors 435, which may also be referred to as computational storage processors, computational engines, or engines, Processors 435 may offer one or more services 440-1 and 440-2, which may be referred to collectively as services 440, and which may be also be referred to as computational storage services (CSSs) or functions. To be clearer, each processor 435 may offer any number (one or more) services 440 (although embodiments of the disclosure may include computational device 410-1 including exactly two services 440-1 and 440-2 as shown in FIG. 4A). Services 440 may be functions that are built into processors 435, functions downloaded from processor 110 of FIG. 1 (that is, custom functions that processor 110 of FIG. 1 wants supported by processors 435), or both. Computational device 410-1 may be reachable across management queue pair 445 and/or I/O queue pair 450, which may be used for management of computational device 410-1 and/or to control I/O of computational device 410-1 respectively, similar to queue pairs 425 and 430 for storage device 405. (Management queue pair 445 and I/O queue pair 450 may be referred to more generally as queue pairs 445 and 450, without reference to their specific usage.) Like queue pairs 425 and 430, other forms of access may be used other than queue pairs 445 and 450, and a single queue pair may be used both for management and I/O control of computational device 410-1 (that is, queue pairs 445 and 450 may be combined in one queue pair).

Processors 435 may be thought of as near-storage processing: that is, processing that is closer to storage device 405 than processor 110 of FIG. 1. Because processors 435 are closer to storage device 405, processors 435 may be able to execute commands on data stored in storage device 405 more quickly than for processor 110 of FIG. 1 to execute such commands. While not shown in FIG. 4A, processors 435 may have associated memory which may be used for local execution of commands on data stored in storage device 405.

While FIG. 4A shows storage device 405 and computational device 410-1 as being separately reachable across fabric 140, embodiments of the disclosure may also include storage device 405 and computational device 410-1 being serially connected. That is, commands directed to storage device 405 and computational device 410-1 might both be received at the same physical connection to fabric 140 and may pass through one device to reach the other. For example, if computational device 410-1 is located between storage device 405 and fabric 140, computational device 410-1 may receive commands directed to both computational device 410-1 and storage device 405: computational device 410-1 may process commands directed to computational device 410-1, and may pass commands directed to storage device 405 to storage device 405.

Services 440 may offer a number of different functions that may be executed on data stored in storage device 405. For example, services 440 may offer pre-defined functions, such as encryption, decryption, compression, and/or decompression of data, erasure coding, and/or applying regular expressions. Or, services 440 may offer more general functions, such as data searching and/or SQL functions. Services 440 may also support running application-specific code. That is, the application using services 440 may provide custom code to be executed using data on storage device 405. In some embodiments of the disclosure, services 440 may be stored in “program slots”: that is, particular addresses ranges within processors 435. Services 440 may also any combination of such functions. Table 1 lists some examples of services that may be offered by processors 435.

TABLE 1
Service Types

Compression
Encryption
Database filter
Erasure coding
RAID (Redundant Array of
Independent Disks)
Hash/CRC (Cyclic Redundancy
Check)
RegEx (Regular Expression/pattern
matching)
Scatter Gather
Pipeline
Video compression
Data Deduplication
Operating System Image Loader
Container Image Loader
Berkeley packet filter (BPF) loader
FPGA Bitstream loader
Large Data Set

Processors 435 (and, indeed, computational device 410-1) may be implemented in any desired manner. Example implementations may include a local processor, such as Central Processing Unit (CPU), a Graphics Processing Unit (GPU), a General Purpose GPU (GPGPU), a Data Processing Unit (DPU), and a Tensor Processing Unit (TPU), among other possibilities. Processors 435 may also be implemented using Field Programmable Gate Array (FPGA), an Application-Specific Integrated Circuit (ASIC), or a System-on-a-Chip, among other possibilities. If computational device 410-1 includes more than one processor 435, each processor 435 may be implemented as described above. For example, computational device 410-1 might have one each of CPU, TPU, and FPGA, or computational device 410-1 might have two FPGAs, or computational device 410-1 might have two CPUs and one ASIC, etc.

Depending on the desired interpretation, either computational device 410-1, processor(s) 435, or the combination may be thought of as a computational storage unit.

Whereas FIG. 4A shows storage device 405 and computational device 410-1 as separate devices, in FIG. 4B they may be combined into a single computational device. Thus, computational device 410-2 may include controller 415, storage 420-1, and processor(s) 435 offering services 440-1 and 440-2. As with storage device 405 and computational device 410-1 of FIG. 4A, management and I/O commands may be received via queue pairs 445 and/or 450. Even though computational device 410-2 is shown as including both storage and processor(s) 435, FIG. 4B may still be thought of as including a storage device that is associated with a computational storage unit.

In yet another variation shown in FIG. 4C, computational device 410-3 is shown. Computational device 410-3 may include controller 415 and storage 420-1, as well as processor(s) 435 offering services 440-1 and 440-2. But even though computational device 410-3 may be thought of as a single component including controller 415, storage 420-1, and processor(s) 435 (and also being thought of as a storage device associated with a computational storage unit), unlike the implementation shown in FIG. 4B controller 415 and processor(s) 435 may each include their own queue pairs 425 and/or 430 and 445 and/or 450 (again, which may be used for management and/or I/O). By including queue pairs 425 and/or 430, controller 415 may offer transparent access to storage 420-1 (rather than requiring all communication to proceed through processor(s) 435), whereas queue pairs 445 and/or 450 may be used to access processor(s) 435.

In addition, processor(s) may have proxied storage access 455 to use to access storage 420-1. Instead of routing access requests through controller 415, processor(s) 435 may be able to directly access the data from storage 420-1 using proxied storage access 455.

In FIG. 4C, both controller 415 and proxied storage access 455 are shown with dashed lines to represent that they are optional elements, and may be omitted depending on the implementation.

Finally, FIG. 4D shows yet another implementation. In FIG. 4D, computational device 410-4 is shown, which may include an array, which may include one or more storage 420-1 through 420-4. While FIG. 4D shows four storage elements, embodiments of the disclosure may include any number (one or more) of storage elements. In addition, the individual storage elements may be other storage devices, such as those shown in FIGS. 4A-4D.

Because computational device 410-4 may include more than one storage element 420-1 through 420-4, computational device 410-4 may include array controller 460. Array controller 460 may manage how data is stored on and retrieved from storage elements 420-1 through 420-4. For example, if storage elements 420-1 through 420-4 are implemented as some level of a Redundant Array of Independent Disks (RAID), array controller 460 may be a RAID controller. If storage elements 420-1 through 420-4 are implemented using some form of Erasure Coding, then array controller 460 may be an Erasure Coding controller.

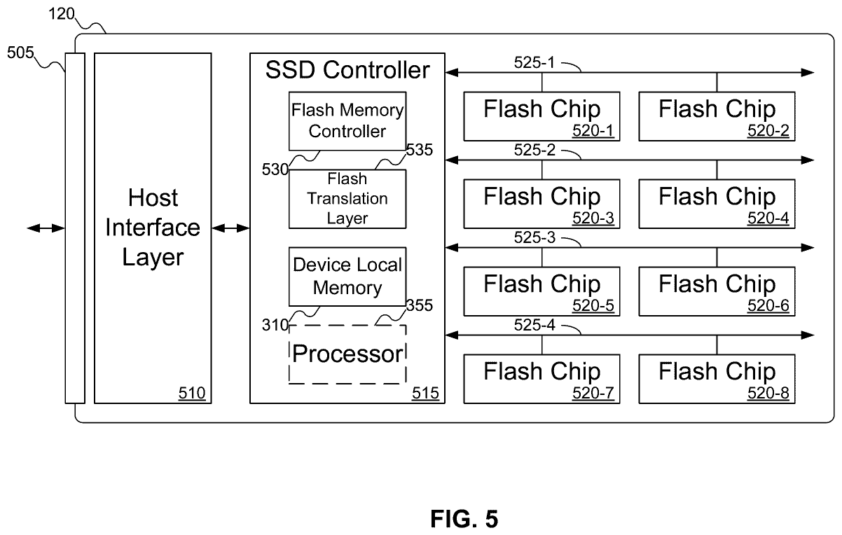

FIG. 5 shows details of memory device 120 of FIG. 1, according to embodiments of the disclosure. In FIG. 5, memory device 120 is shown using an implementation including SSD 120, but embodiments of the disclosure are applicable to any type of memory device that may perform garbage collection or media management, as discussed below.

SSD 120 may include interface 505 and host interface layer 510. Interface 505 may be an interface used to connect SSD 120 to machine 105 of FIG. 1. SSD 120 may include more than one interface 505: for example, one interface might be used for block-based read and write requests, and another interface might be used for key-value read and write requests. While FIG. 5 suggests that interface 505 is a physical connection between SSD 120 and machine 105 of FIG. 1, interface 505 may also represent protocol differences that may be used across a common physical interface. For example, SSD 120 might be connected to machine 105 using a U.2, Enterprise and Datacenter Standard Form Factor (EDSFF), or an M.2 connector, among other possibilities, and SSD 120 may support block-based requests and key-value requests: handling the different types of requests may be performed by a different interface 505. SSD 120 may also include a single interface 505 that may include multiple ports, each of which may be treated as a separate interface 505, or just a single interface 505 with a single port, and leave the interpretation of the information received over interface 505 to another element, such as SSD controller 515.

Host interface layer 510 may manage interface 505, providing an interface between SSD controller 515 and the external connections to SSD 120. If SSD 120 includes more than one interface 505, a single host interface layer 510 may manage all interfaces, SSD 120 may include a host interface layer 510 for each interface, or some combination thereof may be used.

SSD 120 may also include SSD controller 515 and various flash memory chips 520-1 through 520-8, which may be organized along channels 525-1 through 525-4. Flash memory chips 520-1 through 520-8 may be referred to collectively as flash memory chips 520, and may also be referred to as flash chips, memory chips, NAND chips, chips, or dies. Channels 525-1 through 525-4 may be referred to collectively as channels 525. Flash memory chips 520 collectively may represent device persistent storage 315 of FIG. 3. SSD controller 515 may manage sending read requests and write requests to flash memory chips 520 along channels 525. Controller 515 may also include flash memory controller 530, which may be responsible for issuing commands to flash memory chips 520 along channels 525. Flash memory controller 530 may also be referred to more generally as memory controller 530 in embodiments of the disclosure where memory device 120 stores data using a technology other than flash memory chips 520. Although FIG. 5 shows eight flash memory chips 520 and four channels 525, embodiments of the disclosure may include any number (one or more, without bound) of channels 525 including any number (one or more, without bound) of flash memory chips 520.

Within each flash memory chip or die, the space may be organized into planes. These planes may include multiple erase blocks (which may also be referred to as blocks), which may be further subdivided into wordlines. The wordlines may include one or more pages. For example, a wordline for Triple Level Cell (TLC) flash media might include three pages, whereas a wordline for Multi-Level Cell (MLC) flash media might include two pages.

Erase blocks may also be logically grouped together by controller 515, which may be referred to as a superblock. This logical grouping may enable controller 515 to manage the group as one, rather than managing each block separately. For example, a superblock might include one or more erase blocks from each plane from each die in memory device 120. So, for example, if memory device 120 includes eight channels, two dies per channel, and four planes per die, a superblock might include 8×2×4=64 erase blocks.

SSD controller 515 may also include flash translation layer (FTL) 535 (which may be termed more generally a translation layer, for storage devices that do not use flash storage). FTL 535 may handle translation of LBAs or other logical IDs (as used by processor 110 of FIG. 1) and physical block addresses (PBAs) or other physical addresses where data is stored in flash chips 520. FTL 535, may also be responsible for tracking data as it is relocated from one PBA to another, as may occur when performing garbage collection and/or wear leveling.

Finally, in some embodiments of the disclosure, SSD controller 515 may include device local memory 310 and processor 355 (in embodiments of the disclosure where SSD 120 includes processor 355). Note that SSD 120 might include device local memory 310 and/or processor 355 somewhere else in SSD 120 other than SSD controller 515: FIG. 5 shows SSD controller 515 as including device local memory 520 and processor 355 merely as an example location for these elements.

FIG. 6A shows a first example of data structure 325 of FIG. 3 used to manage where data is stored in various memories, according to embodiments of the disclosure. In FIG. 6A, data structure 325 may include a tree, such as a scalable interval tree. An interval tree is a data structure for searching for information that may involve a range of values. For efficient searching, an interval tree may be balanced, so that the worst case time to search an interval tree is generally not significantly worse than the average case time to search the interval tree.

Scalable interval tree 325 is shown as including nodes 605-1 through 605-5, which may be referred to collectively as nodes 605. Each node 605 may represent a portion range of data: for example, a range of addresses associated with data on memory device 120 of FIG. 1. In some embodiments of the disclosure, scalable interval tree 325 (or data structure 325) may be associated with a single file rather than the entire data span of memory device 120 of FIG. 1, in which case there may be more than one scalable interval tree 325/data structure 325 used by machine 105 of FIG. 1.

Each node 605 may identify the data associated with that node 605. For example, node 605-1 may represent data associated with the address range 6-8 megabytes (MB), whereas node 605-4 may represent data associated with the address range 0-2 MB.

Each node 605 may also indicate where the data it represents is currently stored. For example, cross-hatching in FIG. 6A might represent data stored in memory 115 of FIG. 1 and diagonal lines might represent data stored in device local memory 310 of FIG. 3. Thus, the data represented by nodes 605-1 and 605-5 might be currently stored in device local memory 310 of FIG. 3, whereas the data represented by nodes 605-2, 605-3, and 605-4 might currently be stored in memory 115 of FIG. 1. Additional indicators may be used for other types of memory, such as the various levels of processor software cache 305 of FIG. 3 or device persistent storage 315 of FIG. 3. In addition, nodes 605 may indicate that particular data are stored at multiple locations. For example, a particular data might be stored in memory 115 of FIG. 1, device local memory 310 of FIG. 3, and device persistent storage 315 of FIG. 3. The location that might offer the fastest access to the data, factoring in all relevant considerations, may then be selected. Such factors may include the time to access the relevant location, the time required by the host and/or device to complete a request, the bandwidth and queue length for the device, and the queue processing time, among other possibilities. For example, data that is currently stored in memory 115 of FIG. 1 might currently have a relatively long queue of requests waiting for completion, whereas device persistent storage 315 of FIG. 3 might have a relatively short queue of requests, and reading the data from device persistent storage 315 of FIG. 3 might actually be faster than reading the data from memory 115 of FIG. 1

In some embodiments of the disclosure, particularly embodiments of the disclosure including only one device persistent storage 315 of FIG. 3, it may be assumed that the data is always available from device persistent storage 315 of FIG. 3. Thus, data structure 325 may omit device persistent storage 315 of FIG. 3 from the lists of locations where data may be stored, and device persistent storage 315 of FIG. 3 may be assumed to be the only available location for the data if not indicated otherwise in data structure 325.

Note the lock symbols 610-4 and 610-5 (which may be referred to collectively as locks 610) next to nodes 605-4 and 605-5, respectively. As mentioned with reference to FIG. 3 above, multi-threaded access to data structure 325 might result in conflicts in attempts to access data. For example, if two different threads both attempt to write to the same data, the data might be left in an inconsistent state, or one thread might think that its write is still valid when in fact its data was overwritten by the other thread. To avoid this situation, nodes 605 may support locks 610. Lock 610 may be issued to a particular thread, with the other thread blocked to access the data until lock 610 is released. Locks 610 may be assigned and released using any desired lock approach.

Because scalable interval tree 325 may include any number of nodes 605 in any configuration, nodes 605 may be implemented using data structures that include data and pointers to other locations in memory, which may support easy insertion and deletion of nodes 605 as data is updated.

FIG. 6B shows a second example of data structure 325 of FIG. 3 used to manage where data is stored in various memories, according to embodiments of the disclosure. Rather than using a data structure that is dynamically managed like a tree with pointers, data structure 325 may be implemented using arrays of entries 605 that include the relevant information. For example, in FIG. 6B table 325 may include entries 605. Entries may include address ranges 615-1 through 615-5 (which may be referred to collectively as address ranges 615), locations 620-1 through 620-5 (which may be referred to collectively as locations 620), and locks 610 indicating whether the data is currently locked. For example, entry 605-1 may represent the data associated with address range 6-8 MB (address range 615-1), which may currently be stored in device local memory (DLM) 310 of FIG. 3 (location 620-1), and is not currently locked (lock 610-1). On the other hand, entry 605-4 may represent the data associated with address range 0-2 MB (address range 615-4), which may currently be stored in processor software cache (PSC) 305 of FIG. 3 (location 620-4), and is currently locked (lock 610-4). For entries 605 that are currently locked, entries 605 may also include the thread identifier that currently holds the lock to that data. As discussed above with reference to FIG. 6A, table 325 may be modified to reflect that various data may available at multiple locations and to indicate at which locations the data may be located.

Regardless of whether data structure 325 is implemented as a scalable interval tree as shown in FIG. 6A, a table as shown in FIG. 6B, or any other implementation, all of which may be included in various embodiments of the disclosure, data structure 325 may be relatively small. For example, the amount of data needed to represent one terabyte (TB) of memory storage might be only 32 MB: approximately 0.0005% of the size of the data. Thus, data structure 325 should fit easily into memory 115 of FIG. 1, even when machine 105 of FIG. 1 includes very large amounts of memory 115 of FIG. 1 and memories 305, 310, and 315 of FIG. 3. Note that the size of the data range managed by each entry 605 may be set to any desired value: 2 MB ranges are merely presented as examples. Larger data range sizes may result in fewer entries 605 (or nodes 605 in FIG. 6A), leading to a smaller size for data structure 325; smaller data range sizes may result in more entries 605 (or nodes 605 in FIG. 6A), leading to a larger size for data structure 325.

As mentioned with reference to FIG. 3, processor 110 of FIG. 1 and/or memory device 120 of FIG. 1 may notify library 335 of FIG. 3 as data is added to or evicted from processor software cache 305 of FIG. 3, memory 115 of FIG. 1, device local memory 310 of FIG. 3 and/or device persistent storage 315 of FIG. 3. A function of library 335 may then use this information to update data structure 325 of FIGS. 6A-6B accordingly, to maintain current information about what data is stored where.

FIG. 7 shows details of analysis engine 360 of FIG. 3, according to embodiments of the disclosure. In FIG. 7, analysis engine 360 may include data locator 705. Data locator 705 is not intended to be an alternative to data structure 325 of FIG. 3, but rather may determine what data is to be processed by processing request 365 of FIG. 3 and may use data structure 325 of FIG. 3 to determine where that data is currently stored. Calculator 710 may then calculate an estimated time for processor 110 of FIG. 1 to perform the processing request and for processor 355 of FIG. 3 to perform the processing request. Assignment unit 715 may then dispatch processing request 365 of FIG. 3 to processor 110 of FIG. 1, processor 355 of FIG. 3, or both if processor 110 of FIG. 1 and processor 355 of FIG. 3 are to work collaboratively to execute processing request 365 of FIG. 3.

Note that in some situations, the choice of where assignment unit 715 should dispatch processing request 365 of FIG. 3 may be obvious. For example, if memory device 120 of FIG. 1 does not include processor 355 of FIG. 4, or if processor 355 of FIG. 3 is only capable of executing pre-installed functions which do not include the function requested in processing request 365 of FIG. 3, then processing request 365 of FIG. 3 may be dispatched to processor 110 of FIG. 1 for execution automatically. Similarly, if processor 355 of FIG. 4 is capable of executing processing request 365 of FIG. 3 and all the data to be processed is currently in device local memory 310 of FIG. 3 or device persistent storage 315 of FIG. 3, then it probably is more efficient for processor 355 of FIG. 3 to execute processing request 365 of FIG. 3 than for processor 110 of FIG. 1 to execute processing request 365 of FIG. 3 (although a backlog of processing by processor 355 of FIG. 3 might change that result). But in the more general case, data might be split between memory 115 of FIG. 1 and device local memory 310 of FIG. 3, and the analysis becomes more complicated, using the results of calculator 710.

FIG. 8 shows details of calculator 710 of FIG. 7, according to embodiments of the disclosure. Calculator 710 may take various pieces of data to calculate estimated host processing time 805 and estimated device processing time 810, which assignment unit 715 of FIG. 7 may then use to dispatch processing request 365 of FIG. 3 appropriately. Such calculation may factor in data locations 815 that indicate where the data to be processed is currently stored (as determined by data locator 705 using data structure 325 of FIG. 3), host execution time 820 and device execution time 825, which estimate how long processor 110 of FIG. 1 and processor 355 of FIG. 3 might each take to execute processing request 365 of FIG. 3 given all the data is available, bandwidths 830, which may factor into how long it takes to move data between processor software cache 305 of FIG. 3, memory 115 of FIG. 1, and device local memory 310 of FIG. 3, I/O queue length 835, which may indicate how many requests are already pending in I/O queues for memory device 120 of FIG. 1, and I/O queue processing time 840, which may specify how long on average it takes memory device 120 to handle a single I/O request in the I/O queue.

In general, host processing time 805 and device processing time 810 may be estimated using the following equations:

$${T}_{h} = \frac{{DR}_{dm}}{{B}_{hm - dm}} + \frac{{DR}_{ds}}{{B}_{hm - ds}} + {E}_{h}$$

$${T}_{d} = \frac{{DR}_{hm}}{{B}_{hm - dm}} + \frac{{DR}_{ds}}{{B}_{ds - dm}} + ( {C}_{davg} * {Q}_{len} ) + {E}_{d}$$

In the above equations, T refers to the estimated time, DR refers to the ratio of the data in a particular memory, B refers to the bandwidth between memories, E refers to the average execution time, C_{davg} refers to the average time for memory device 120 of FIG. 1 to process an I/O request, and Qₗₑₙ refers to the length of the I/O queue for memory device 120 of FIG. 1. The subscript h refers to processor 110 of FIG. 1, d refers to processor 355 of FIG. 3, hm refers to processor software cache 305 of FIG. 1/memory 115 of FIG. 1, dm refers to device local memory 310 of FIG. 3, and ds refers to device persistent storage 315 of FIG. 3. For bandwidths, two subscripts are shown to indicate that the bandwidth is between the two devices, as different pairs of devices may have different bandwidths between them. Thus, for example, B_{hm-dm} refers to the bandwidth between memory 115 of FIG. 1 and device local memory 310 of FIG. 3, whereas B_{ds-dm} refers to the bandwidth between device persistent storage 315 of FIG. 3 and device local memory 310 of FIG. 3.

Calculator 710 may take the various inputs shown and generate the estimated times for processor 110 of FIG. 1 and for processor 355 of FIG. 3 to execute processing request 365. Note that other embodiments of the disclosure may apply different formulae to estimate host and device processing times, and may use different combinations of inputs (and even different inputs entirely not shown in FIG. 8).

In some embodiments of the disclosure, hard-coded rules may be used. That is, given that data is stored at a particular location, requests to access the data might always be sent to that location, regardless of other factors. So, for example, if the data in question is known to be stored in PSC 305 of FIG. 3, any request to access the data might automatically be sent to PSC 305 of FIG. 3, even if the data might also be stored in other layers. Similarly, hard-coded rules may be used to direct that particular requests to process the data may be sent to particular devices. For example, embodiments of the disclosure might direct a particular processing request 365 to a particular processor 110 of FIG. 1, regardless of the availability of other processors 110 of FIG. 1.

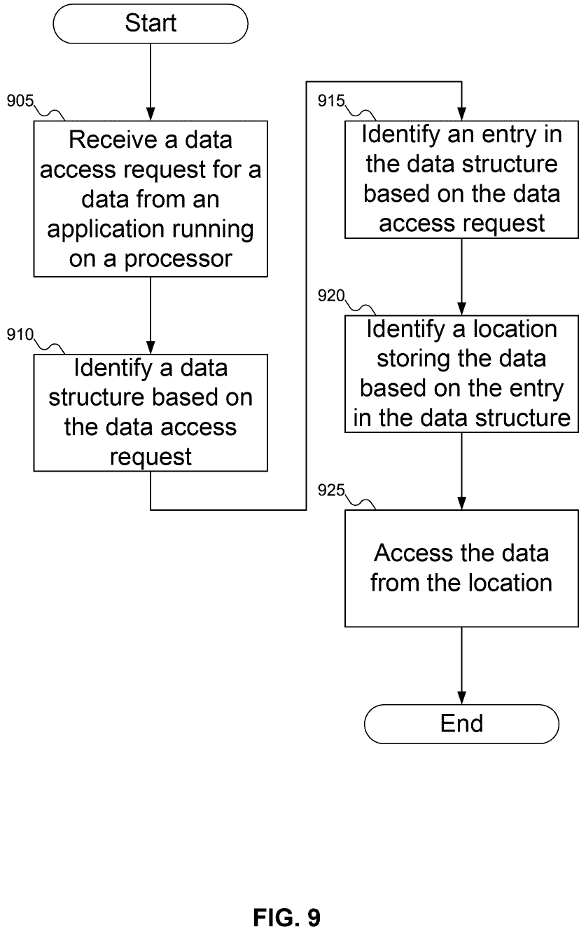

FIG. 9 shows a flowchart of an example procedure for machine 105 of FIG. 1 to process data access request 320 of FIG. 3, according to embodiments of the disclosure. In FIG. 9, at block 905, library 335 of FIG. 3 may receive data access request 320 of FIG. 3 from application 330 of FIG. 3. At block 910, data structure 325 of FIG. 3 may be identified. For example, data structure 325 of FIG. 3 may be identified based on what data is requested by data access request 320 of FIG. 3. At block 915, entry 605 of FIG. 6 in data structure 325 of FIG. 3 may be identified. At block 920, based on entry 605 of FIG. 6 in data structure 325 of FIG. 3, memory 115 of FIG. 1, processor software cache 305 of FIG. 3, device local memory 310, or device persistent memory 315 of FIG. 3 may be identified. Finally, at block 925, the data requested in data access request 320 of FIG. 3 may be accessed from memory 115 of FIG. 1, processor software cache 305 of FIG. 3, device local memory 310, or device persistent storage 315 of FIG. 3.

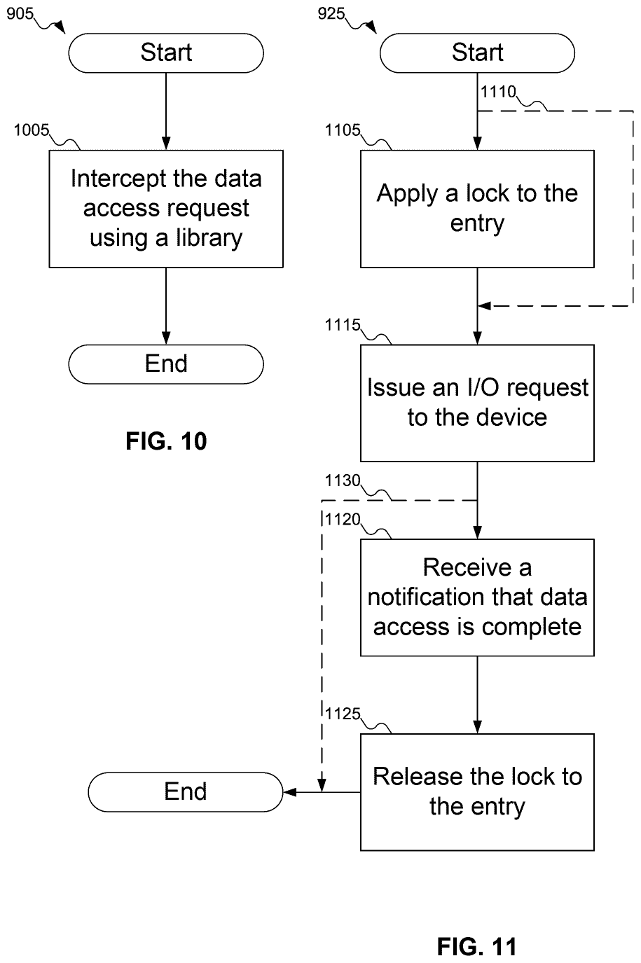

FIG. 10 shows a flowchart of an example procedure for machine 105 of FIG. 1 to receive data access request 320 of FIG. 3, according to embodiments of the disclosure. In FIG. 10, at block 1005, library 335 of FIG. 3 may intercept data access request 320 of FIG. 3 from application 330 of FIG. 3.

FIG. 11 shows a flowchart of an example procedure for machine 105 of FIG. 1 to lock and unlock access to data in the various memories, according to embodiments of the disclosure. In FIG. 11, at block 1105, lock 610 of FIG. 6 may be applied to entry 605 of FIG. 6. Block 1105 may be omitted, as shown by dashed line 1110: for example, if data structure 325 of FIG. 3 is not accessed by multiple threads. At block 1115, an I/O request may be issued to memory device 120 of FIG. 1 to access the data requested in data access request 320 of FIG. 3. Note that if the data is stored in memory 115 of FIG. 1, processor software cache 305, or device local memory 310 of FIG. 3 (assuming that processor 110 of FIG. 1 may access device local memory 310 of FIG. 3), then the data may be accessed in other ways than using an I/O request. At block 1120, library 335 of FIG. 3 may be notified that the thread has completed access to the data, and at block 1125 lock 610 of FIG. 6 may be released. Blocks 1120 and 1125 may be omitted, as shown by dashed line 1130: for example, if data structure is not accessed by multiple threads.

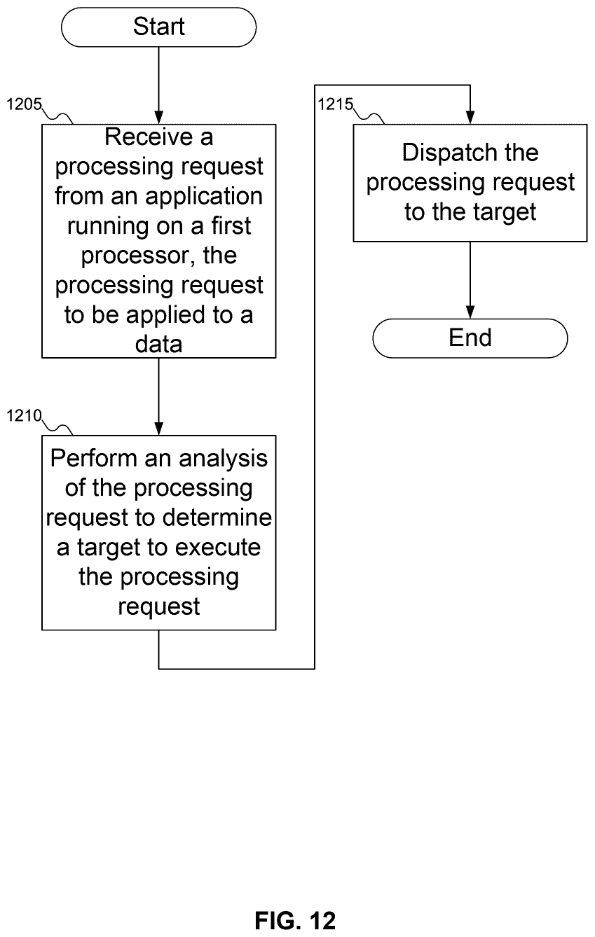

FIG. 12 shows a flowchart of an example procedure for machine 105 of FIG. 1 to process processing request 365 of FIG. 3, according to embodiments of the disclosure. In FIG. 12, at block 1205, processing request 365 of FIG. 3 may be received from application 330 of FIG. 3. Processing request 325 of FIG. 3 may specify data to be processed using a particular function or program. At block 1210, analysis engine 360 of FIG. 3 may perform an analysis to determine whether processor 110 or processor 355 of FIG. 3 should execute processing request 365 of FIG. 3. Finally, at block 1215, assignment unit 715 of FIG. 7 may dispatch processing request 365 of FIG. 3 to processor 110 of FIG. 1, processor 355, or to both to execute collaboratively.

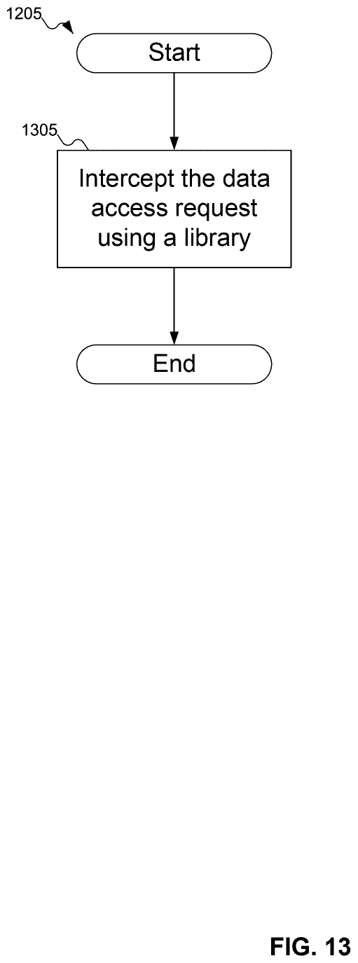

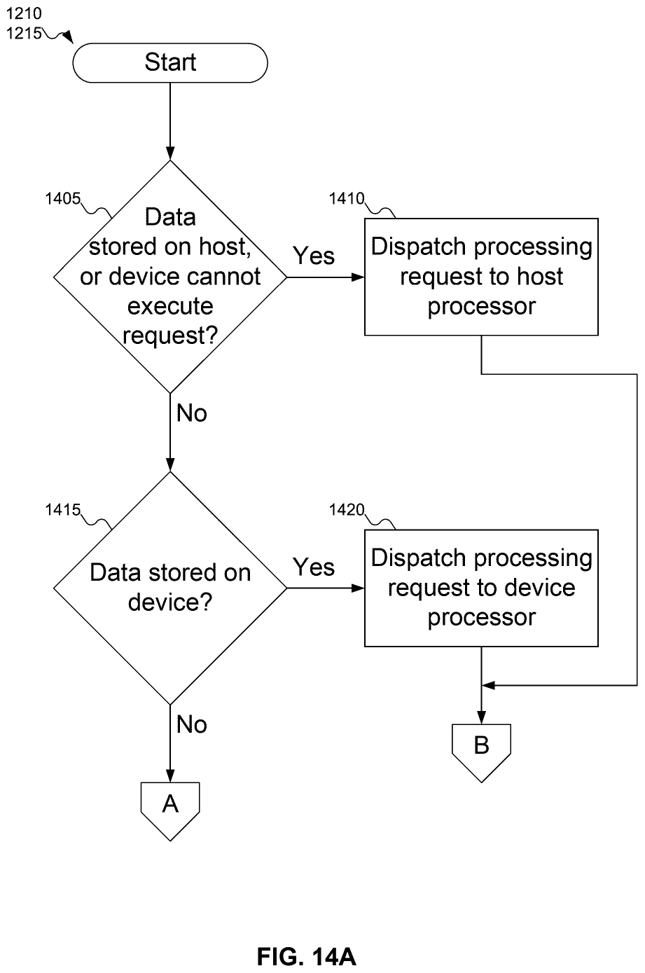

FIG. 13 shows a flowchart of an example procedure for machine 105 of FIG. 1 to receive processing request 365 of FIG. 3, according to embodiments of the disclosure. In FIG. 13, at block 1305, library 335 of FIG. 3 may intercept processing request 365 from application 330 of FIG. 3.

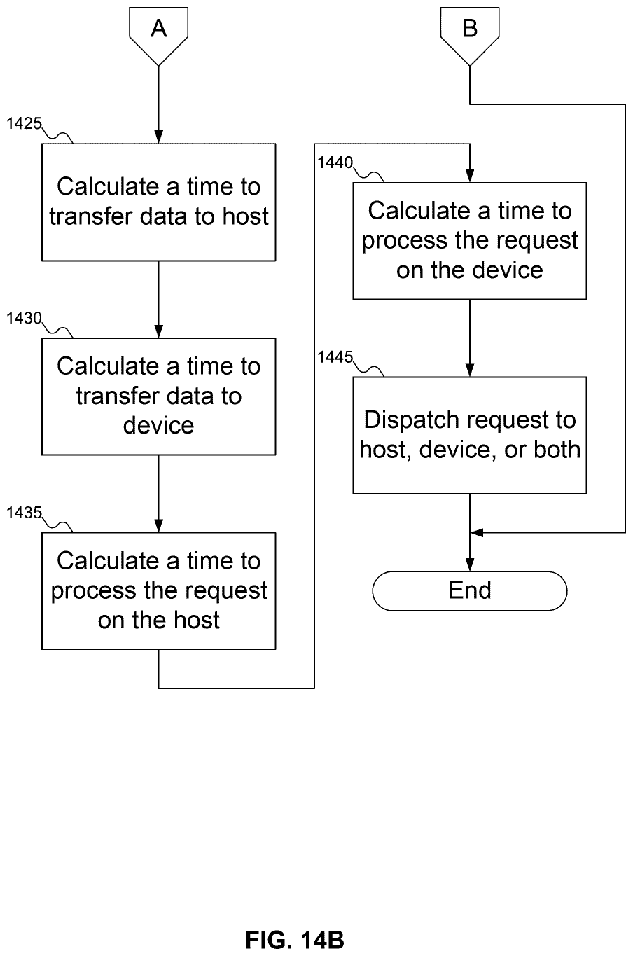

FIGS. 14A-14B show a flowchart of an example procedure for machine 105 of FIG. 1 to determine where to process processing request 365 of FIG. 3, according to embodiments of the disclosure. In FIG. 14A, at block 1405, analysis engine 360 of FIG. 3 may determine whether the data to be processed by processing request 365 of FIG. 3 is stored on the host (that is, in memory 115 or processor software cache 305 of FIG. 3). Analysis engine 360 of FIG. 3 may also determine whether processor 355 of FIG. 3 may execute processing request 365 of FIG. 3. If the data in stored in memory 115 or processor software cache 305, or if processor 355 of FIG. 3 is not capable of executing processing request 365 of FIG. 3, then at block 1410 assignment unit 715 of FIG. 7 may dispatch processing request 365 of FIG. 3 to processor 110 of FIG. 1.

If the data is not stored (or not entirely stored) in memory 115 or in processor software cache 305 of FIG. 3, then at block 1415 analysis engine 360 of FIG. 3 may determine if the data is stored on memory device 120 of FIG. 1 (that is, in device local memory 310 or device persistent storage device 315 of FIG. 3). If so, then at block 1420, assignment unit 715 of FIG. 7 may dispatch processing request 365 of FIG. 3 to processor 355 of FIG. 3.

If the data not stored entirely on the host or on memory device 120 of FIG. 1, then at block 1425, calculator 710 of FIG. 7 calculates a time to move the data to be processed by processing request 365 of FIG. 3 from the host to memory device 120, and at block 1430 calculator 710 of FIG. 7 calculates a time to move the data to be processed by processing request 365 of FIG. 3 from memory device 120 of FIG. 1 to the host. Then, at block 1435, calculator 710 of FIG. 7 calculates estimated host processing time 805, and at block 1440, calculator 710 of FIG. 7 calculates estimated device processing time 810 of FIG. 8. Finally, at block 1445, assignment unit 715 of FIG. 7 dispatches processing request 365 of FIG. 3 to processor 110 of FIG. 1, processor 355, or to both to collaboratively execute processing request, based on estimated host processing time 805 and estimated device processing time 810 of FIG. 8.

In FIGS. 9-14B, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

Embodiments of the disclosure may include a data structure that may identify which memory in a tiered memory system stores a particular data. The data structure may be accessed when a data access request is issued to determine where the data is currently stored. The use of the data structure may offer a technical advantage in faster retrieval of the data.

Some embodiments of the disclosure may also include an analysis engine. The analysis engine may determine whether a data processing request may be executed more efficiently on the host processor or in a processor associated with a memory device (such as a computational storage unit). The processing request may then be dispatched where the processing request may be most efficiently executed, which may include collaborative execution of the processing request by the host processor and the processor in the memory device. The use of the analysis engine may offer a technical advantage in more efficient execution of data processing.

Using a host cache may result in high input/output (I/O) access time and data movement costs when data misses host cache. Embodiments of the disclosure may address such issues by using scalable indexing for concurrent access to host cache and device Dynamic Random Access Memory (DRAM).

For storage devices that include co-processors/accelerators/computational devices, concurrent data processing at both the host and device may be possible. Dynamic model-driven offloading support across the host and the device may be achieved by actively monitor hardware and software metrics for efficient processing.

Embodiments of the disclosure may support collaborative caching exploiting near-storage memory (accessible via a cache-coherent interconnect protocol, such as the Compute Express Link (CXL) protocol, or via the Non-Volatile Memory Express (NVMe) specification). A host-managed scalable index may map a range of blocks in a file to different caches, allowing concurrent access to these blocks. Embodiments of the disclosure may therefore offer improved application performance and reduced central processing unit (CPU) stalls.

Embodiments of the disclosure may include a Cache manager, which may handle I/O and data processing flows concurrently.

### User-Level Runtime:

An application may issue an I/O request, which a runtime library may intercept. The runtime library may use a scalable interval tree to locate the data in host or device RAM or storage. Cache misses may be dispatched as I/O requests to the device using I/O queues.

### Near-Storage Cache Manager:

A near-storage cache manager may fetch a request from I/O queues, and may read a block from storage to near-storage cache to apply changes to the cache. For data processing operations (e.g., K nearest neighbor search), the application may invoke a pre-defined read-CRC-write function using the runtime library.

The scalable interval tree may use a dynamic model component to decide whether to process the request in the host, in the device, or collaboratively on both. The dynamic model component may be based on an analytical approach which may calculate the approximate time to process a request either on the host or the device before processing.

An example function (read-cal_distance_nearestK) may be concurrently executed on both the host and the device.

$$Th = RdD / Bhm\_dm + RsD / Bds\_hm + Ehavg$$

$$Td = RhD / Bhm\_dm + RsD / Bds\_dm + Cmdavg * Qlen + Edavg$$

The above equations may be used to calculate the processing time for a request on the host (Th) and the device (Td), respectively.

Data Ratio (R) may represent data associated with a request can be distributed across HostCache, DevCache, and storage. The ratios Rhm, Rdm, and Rs may represent the portions of data in the host memory (hm), device memory (dm), and storage(s) for each request.

Execution Time (E) may capture the processing cost alone, Ehavg may represent the average time to execute a request on the host, while Edavg may represent the average time on the device.

Data Transfer Cost (B) may capture the data movement between HostCache, DevCache, and storage. Bhm_dm may denote the data transfer bandwidth between HostCache and DevCache, Bds_hm may represent the bandwidth between storage and HostCache, and Bds_dm may represent the bandwidth between storage and DevCache.

Queue Latency (Qlen) may represent the completion time of a request, and may depend on the time the request spends in the queue. This time may vary based on the number of regular and data-processing requests in the per-file I/O queue and the average time required for processing the requests, indicated by Cmdavg*Qlen.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Embodiments of the disclosure may extend to the following statements, without limitation:

Statement 1. An embodiment of the disclosure includes a system, comprising:
a processor;
a first memory connected to the processor;
a second memory connected to the processor; and
a data structure, the data structure including at least an entry, the entry identifying that a data is stored in a location, the location including one of the first memory or the second memory.

Statement 2. An embodiment of the disclosure includes the system according to statement 1, wherein the first memory includes a processor cache or a main memory.

Statement 3. An embodiment of the disclosure includes the system according to statement 1, wherein the second memory includes a device local memory or a device persistent storage.

Statement 4. An embodiment of the disclosure includes the system according to statement 1, further comprising a device, the device including the second memory.

Statement 5. An embodiment of the disclosure includes the system according to statement 1, further comprising a library to intercept a data access request from an application running on the processor to access the data.

Statement 6. An embodiment of the disclosure includes the system according to statement 1, wherein:
the data structure includes a scalable interval tree; and
the entry includes a node in the scalable interval tree.

Statement 7. An embodiment of the disclosure includes the system according to statement 1, wherein the data structure is stored in the first memory.

Statement 8. An embodiment of the disclosure includes the system according to statement 1, wherein the data structure is associated with a file.

Statement 9. An embodiment of the disclosure includes the system according to statement 8, further comprising a second data structure including at least a second entry, the second data structure associated with a second file.

Statement 10. An embodiment of the disclosure includes the system according to statement 1, wherein the entry includes a lock.

Statement 11. An embodiment of the disclosure includes the system according to statement 10, wherein the lock is associated with a thread of an application running on the processor, the thread requesting access to the data.

Statement 12. An embodiment of the disclosure includes the system according to statement 1, wherein:
the processor includes a first thread running on the processor and a second thread running on the processor;
the data structure includes at least a second entry, the second entry identifying a second location for a second data; and
the data structure is configured to support the first thread accessing the data from the location and the second thread accessing the second data from the second location.

Statement 13. An embodiment of the disclosure includes the system according to statement 12, wherein the data structure is configured to support the first thread accessing the data from the location and the second thread accessing the second data from the second location in parallel.

Statement 14. An embodiment of the disclosure includes the system according to statement 1, further comprising a device, the device including:
the second memory; and
a second processor.

Statement 15. An embodiment of the disclosure includes the system according to statement 14, further comprising an analysis engine to calculate a first estimated time for a processing request, from an application running on the processor, on a target data on the processor and a second estimated time for the processing request, from the application running on the processor, on the second processor.

Statement 16. An embodiment of the disclosure includes the system according to statement 15, further comprising a library to intercept the processing request from the application running on the processor.

Statement 17. An embodiment of the disclosure includes the system according to statement 15, wherein the analysis engine is configured to assign the processing request, from the application running on the processor, to the processor based at least in part on the target data being in the first memory.

Statement 18. An embodiment of the disclosure includes the system according to statement 15, wherein the analysis engine is configured to assign the processing request, from the application running on the processor, to the processor based at least in part on the second processor not executing the processing request from the application running on the processor.

Statement 19. An embodiment of the disclosure includes the system according to statement 15, wherein the analysis engine is configured to assign the processing request, from the application running on the processor, to the second processor based at least in part on the target data being in the second memory.

Statement 20. An embodiment of the disclosure includes the system according to statement 15, wherein the analysis engine is configured to:
determine that a first part of the target data is stored in the first memory and a second part of the target data is stored in the second memory;
calculate a first estimated time for the processor to execute the processing request from the application running on the processor; and
calculate a second estimated time for the second processor to execute the processing request from the application running on the processor.

Statement 21. An embodiment of the disclosure includes the system according to statement 20, wherein the analysis engine is further configured to dispatch the processing request, from the application running on the processor, to the processor, the second processor, or to both the processor and the second processor.

Statement 22. An embodiment of the disclosure includes the system according to statement 20, wherein the analysis engine is further configured to:
calculate a first transfer time to transfer the second part of the target data to the first memory; and
calculate a second transfer time to transfer the first part of the data to the second memory.

Statement 23. An embodiment of the disclosure includes a method, comprising:
receiving a data access request for a data from an application running on a processor;
identifying a data structure based on the data access request;
identifying an entry in the data structure based on the data access request;
identifying a location storing the data based on the entry in the data structure; and
accessing the data from the location,
wherein the location includes a first memory or a second memory.

Statement 24. An embodiment of the disclosure includes the method according to statement 23, wherein receiving the data access request for the data from the application running on the processor includes intercepting the data access request for the data from the application running on the processor.

Statement 25. An embodiment of the disclosure includes the method according to statement 24, wherein intercepting the data access request for the data from the application running on the processor includes intercepting the data access request for the data from the application running on the processor by a library.

Statement 26. An embodiment of the disclosure includes the method according to statement 23, wherein identifying the data structure based on the data access request includes identifying a scalable interval tree based on the data access request.

Statement 27. An embodiment of the disclosure includes the method according to statement 26, wherein identifying the entry in the data structure based on the data access request includes identifying a node in the scalable interval tree based on the data access request.

Statement 28. An embodiment of the disclosure includes the method according to statement 23, wherein:
receiving the data access request for the data from the application running on the processor includes receiving a second data access request for a second data from the application running on the processor;
identifying the data structure based on the data access request includes identifying the data structure based on the second data access request;
identifying the entry in the data structure based on the data access request includes identifying a second entry in the data structure based on the second data access request; and
identifying the location storing the data based on the entry in the data structure includes identifying the location storing the second data based on the second entry in the data structure.

Statement 29. An embodiment of the disclosure includes the method according to statement 28, wherein identifying the location storing the data based on the entry in the data structure includes identifying the location storing the second data based on the second entry in the data structure in parallel with identifying the location storing the data based on the entry in the data structure.

Statement 30. An embodiment of the disclosure includes the method according to statement 23, wherein the first memory includes a processor cache, a main memory, a device local memory, or a device persistent storage.

Statement 31. An embodiment of the disclosure includes the method according to statement 23, wherein the second memory includes a processor cache, a main memory, a device local memory, or a device persistent storage.

Statement 32. An embodiment of the disclosure includes the method according to statement 23, wherein accessing the data from the location includes accessing the data from the location by the processor.

Statement 33. An embodiment of the disclosure includes the method according to statement 23, wherein accessing the data from the location includes issuing an input/output (I/O) request to a device, the device including the first memory.

Statement 34. An embodiment of the disclosure includes the method according to statement 23, wherein:
receiving the data access request for the data from the application running on the processor includes receiving the data access request for the data from a thread of the application running on the processor; and
accessing the data from the location includes applying a lock to the entry in the data structure for use by the thread.

Statement 35. An embodiment of the disclosure includes the method according to statement 34, further comprising releasing the lock to the entry in the data structure for use by the thread.

Statement 36. An embodiment of the disclosure includes the method according to statement 35, wherein:
the method further comprises receiving a notification that the thread has used the data from the first memory; and
releasing the lock to the entry in the data structure for use by the thread includes releasing the lock to the entry in the data structure for use by the thread based at least in part on receiving the notification that the thread has used the data from the first memory.

Statement 37. An embodiment of the disclosure includes the method according to statement 23, further comprising returning the data to the processor.

Statement 38. An embodiment of the disclosure includes the method according to statement 23, wherein:
the data access request requests data from a file; and
the data structure is for the file.

Statement 39. An embodiment of the disclosure includes the method according to statement 38, wherein a second data structure is for a second file.

Statement 40. An embodiment of the disclosure includes a method, comprising:
receiving a processing request from an application running on a first processor, the processing request to be applied to a data;
performing an analysis of the processing request to determine a target to execute the processing request, the target including the first processor or a second processor associated with a device; and
dispatching the processing request to the target.

Statement 41. An embodiment of the disclosure includes the method according to statement 40, wherein receiving the processing request from the application running on the first processor includes intercepting the processing request for the data from the application running on the first processor.

Statement 42. An embodiment of the disclosure includes the method according to statement 41, wherein intercepting the processing request for the data from the application running on the first processor includes intercepting the processing request for the data from the application running on the first processor by a library.

Statement 43. An embodiment of the disclosure includes the method according to statement 40, wherein:
performing the analysis of the processing request to determine the target to execute the processing request includes determining that the data is stored in a memory associated with of the first processor; and
dispatching the processing request to the target includes dispatching the processing request to the first processor.

Statement 44. An embodiment of the disclosure includes the method according to statement 40, wherein:
performing the analysis of the processing request to determine the target to execute the processing request includes determining that the second processor is not configured to execute the processing request; and
dispatching the processing request to the target includes dispatching the processing request to the first processor.

Statement 45. An embodiment of the disclosure includes the method according to statement 40, wherein:
performing the analysis of the processing request to determine the target to execute the processing request includes determining that the data is stored in a memory associated with the second processor; and
dispatching the processing request to the target includes dispatching the processing request to the second processor.

Statement 46. An embodiment of the disclosure includes the method according to statement 40, wherein performing the analysis of the processing request to determine the target to execute the processing request includes:
determining that a first part of the data is stored in a first memory associated with the first processor and a second part of the data is stored in a second memory associated with the second processor;
calculating a first estimated time for the first processor to execute the processing request; and
calculating a second estimated time for the second processor to execute the processing request.

Statement 47. An embodiment of the disclosure includes the method according to statement 46, wherein dispatching the processing request to the target includes dispatching the processing request to the first processor, the second processor, or to both the first processor and the second processor based at least in part on the first estimated time and the second estimated time.

Statement 48. An embodiment of the disclosure includes the method according to statement 46, wherein:
calculating the first estimated time for the first processor to execute the processing request includes calculating a first transfer time to transfer the second part of the data to the first memory associated with the first processor; and
calculating a second estimated time for the second processor to execute the processing request includes calculating a second transfer time to transfer the first part of the data to the second memory associated with the second processor.

Statement 49. An embodiment of the disclosure includes an article, comprising a non-transitory storage medium, the non-transitory storage medium having stored thereon instructions that, when executed by a machine, result in:
receiving a data access request for a data from an application running on a processor;
identifying a data structure based on the data access request;
identifying an entry in the data structure based on the data access request;
identifying a location storing the data based on the entry in the data structure; and
accessing the data from the location,
wherein the location includes a first memory or a second memory.

Statement 50. An embodiment of the disclosure includes the article according to statement 49, wherein receiving the data access request for the data from the application running on the processor includes intercepting the data access request for the data from the application running on the processor.

Statement 51. An embodiment of the disclosure includes the article according to statement 50, wherein intercepting the data access request for the data from the application running on the processor includes intercepting the data access request for the data from the application running on the processor by a library.

Statement 52. An embodiment of the disclosure includes the article according to statement 49, wherein identifying the data structure based on the data access request includes identifying a scalable interval tree based on the data access request.

Statement 53. An embodiment of the disclosure includes the article according to statement 52, wherein identifying the entry in the data structure based on the data access request includes identifying a node in the scalable interval tree based on the data access request.

Statement 54. An embodiment of the disclosure includes the article according to statement 49, wherein:
receiving the data access request for the data from the application running on the processor includes receiving a second data access request for a second data from the application running on the processor;
identifying the data structure based on the data access request includes identifying the data structure based on the second data access request;
identifying the entry in the data structure based on the data access request includes identifying a second entry in the data structure based on the second data access request; and
identifying the location storing the data based on the entry in the data structure includes identifying the location storing the second data based on the second entry in the data structure.

Statement 55. An embodiment of the disclosure includes the article according to statement 54, wherein identifying the location storing the data based on the entry in the data structure includes identifying the location storing the second data based on the second entry in the data structure in parallel with identifying the location storing the data based on the entry in the data structure.

Statement 56. An embodiment of the disclosure includes the article according to statement 49, wherein the first memory includes a processor cache, a main memory, a device local memory, or a device persistent storage.

Statement 57. An embodiment of the disclosure includes the article according to statement 49, wherein the second memory includes a processor cache, a main memory, a device local memory, or a device persistent storage.

Statement 58. An embodiment of the disclosure includes the article according to statement 49, wherein accessing the data from the location includes accessing the data from the location by the processor.

Statement 59. An embodiment of the disclosure includes the article according to statement 49, wherein accessing the data from the location includes issuing an input/output (I/O) request to a device, the device including the first memory.

Statement 60. An embodiment of the disclosure includes the article according to statement 49, wherein:
receiving the data access request for the data from the application running on the processor includes receiving the data access request for the data from a thread of the application running on the processor; and
accessing the data from the location includes applying a lock to the entry in the data structure for use by the thread.

Statement 61. An embodiment of the disclosure includes the article according to statement 60, the non-transitory storage medium having stored thereon further instructions that, when executed by the machine, result in releasing the lock to the entry in the data structure for use by the thread.

Statement 62. An embodiment of the disclosure includes the article according to statement 61, wherein:
the non-transitory storage medium has stored thereon further instructions that, when executed by the machine, result in receiving a notification that the thread has used the data from the first memory; and
releasing the lock to the entry in the data structure for use by the thread includes releasing the lock to the entry in the data structure for use by the thread based at least in part on receiving the notification that the thread has used the data from the first memory.

Statement 63. An embodiment of the disclosure includes the article according to statement 49, the non-transitory storage medium having stored thereon further instructions that, when executed by the machine, result in returning the data to the processor.

Statement 64. An embodiment of the disclosure includes the article according to statement 49, wherein:
the data access request requests data from a file; and
the data structure is for the file.

Statement 65. An embodiment of the disclosure includes the article according to statement 64, wherein a second data structure is for a second file.

Statement 66. An embodiment of the disclosure includes an article, comprising a non-transitory storage medium, the non-transitory storage medium having stored thereon instructions that, when executed by a machine, result in:
receiving a processing request from an application running on a first processor, the processing request to be applied to a data;
performing an analysis of the processing request to determine a target to execute the processing request, the target including the first processor or a second processor associated with a device; and
dispatching the processing request to the target.

Statement 67. An embodiment of the disclosure includes the article according to statement 66, wherein receiving the processing request from the application running on the first processor includes intercepting the processing request for the data from the application running on the first processor.

Statement 68. An embodiment of the disclosure includes the article according to statement 67, wherein intercepting the processing request for the data from the application running on the first processor includes intercepting the processing request for the data from the application running on the first processor by a library.

Statement 69. An embodiment of the disclosure includes the article according to statement 66, wherein:
performing the analysis of the processing request to determine the target to execute the processing request includes determining that the data is stored in a memory associated with of the first processor; and
dispatching the processing request to the target includes dispatching the processing request to the first processor.

Statement 70. An embodiment of the disclosure includes the article according to statement 66, wherein:
performing the analysis of the processing request to determine the target to execute the processing request includes determining that the second processor is not configured to execute the processing request; and
dispatching the processing request to the target includes dispatching the processing request to the first processor.

Statement 71. An embodiment of the disclosure includes the article according to statement 66, wherein:
performing the analysis of the processing request to determine the target to execute the processing request includes determining that the data is stored in a memory associated with the second processor; and
dispatching the processing request to the target includes dispatching the processing request to the second processor.

Statement 72. An embodiment of the disclosure includes the article according to statement 66, wherein performing the analysis of the processing request to determine the target to execute the processing request includes:
determining that a first part of the data is stored in a first memory associated with the first processor and a second part of the data is stored in a second memory associated with the second processor;
calculating a first estimated time for the first processor to execute the processing request;
and calculating a second estimated time for the second processor to execute the processing request.

Statement 73. An embodiment of the disclosure includes the article according to statement 72, wherein dispatching the processing request to the target includes dispatching the processing request to the first processor, the second processor, or to both the first processor and the second processor based at least in part on the first estimated time and the second estimated time.

Statement 74. An embodiment of the disclosure includes the article according to statement 72, wherein:
calculating the first estimated time for the first processor to execute the processing request includes calculating a first transfer time to transfer the second part of the data to the first memory associated with the first processor; and
calculating a second estimated time for the second processor to execute the processing request includes calculating a second transfer time to transfer the first part of the data to the second memory associated with the second processor.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A system, comprising:
a processor;
a first memory connected to the processor;
a second memory connected to the processor; and
a data structure, the data structure including at least an entry, the entry identifying that a data is stored in a location, the location including one of the first memory or the second memory.

2. The system according to claim 1, further comprising a library to intercept a data access request from an application running on the processor to access the data.

3. The system according to claim 1, wherein:
the data structure includes a scalable interval tree; and
the entry includes a node in the scalable interval tree.

4. The system according to claim 1, wherein
the entry includes a lock; and
the lock is associated with a thread of an application running on the processor, the thread requesting access to the data.

5. The system according to claim 1, further comprising an analysis engine to calculate a first estimated time for a processing request, from an application running on the processor, on a target data on the processor and a second estimated time for the processing request, from the application running on the processor, on a second processor.

6. The system according to claim 5, further comprising a library to intercept the processing request from the application running on the processor.

7. The system according to claim 5, wherein the analysis engine is configured to:
determine that a first part of the target data is stored in the first memory and a second part of the target data is stored in the second memory;
calculate a first estimated time for the processor to execute the processing request from the application running on the processor; and
calculate a second estimated time for the second processor to execute the processing request from the application running on the processor.

8. A method, comprising:
receiving a data access request for a data from an application running on a processor;
identifying a data structure based on the data access request;
identifying an entry in the data structure based on the data access request;
identifying a location storing the data based on the entry in the data structure; and
accessing the data from the location,
wherein the location includes a first memory or a second memory.

9. The method according to claim 8, wherein receiving the data access request for the data from the application running on the processor includes intercepting the data access request for the data from the application running on the processor.

10. The method according to claim 9, wherein intercepting the data access request for the data from the application running on the processor includes intercepting the data access request for the data from the application running on the processor by a library.

11. The method according to claim 8, wherein:
receiving the data access request for the data from the application running on the processor includes receiving a second data access request for a second data from the application running on the processor;
identifying the data structure based on the data access request includes identifying the data structure based on the second data access request;
identifying the entry in the data structure based on the data access request includes identifying a second entry in the data structure based on the second data access request; and
identifying the location storing the data based on the entry in the data structure includes identifying the location storing the second data based on the second entry in the data structure.

12. The method according to claim 8, wherein accessing the data from the location includes accessing the data from the location by the processor.

13. The method according to claim 8, wherein accessing the data from the location includes issuing an input/output (I/O) request to a device, the device including the first memory.

14. The method according to claim 8, wherein:
receiving the data access request for the data from the application running on the processor includes receiving the data access request for the data from a thread of the application running on the processor; and
accessing the data from the location includes applying a lock to the entry in the data structure for use by the thread.

15. A method, comprising:
receiving a processing request from an application running on a first processor, the processing request to be applied to a data;
performing an analysis of the processing request to determine a target to execute the processing request, the target including the first processor or a second processor associated with a device; and
dispatching the processing request to the target.

16. The method according to claim 15, wherein receiving the processing request from the application running on the first processor includes intercepting the processing request for the data from the application running on the first processor.

17. The method according to claim 15, wherein:
performing the analysis of the processing request to determine the target to execute the processing request includes determining that the data is stored in a memory associated with of the first processor; and
dispatching the processing request to the target includes dispatching the processing request to the first processor.

18. The method according to claim 15, wherein performing the analysis of the processing request to determine the target to execute the processing request includes:
determining that a first part of the data is stored in a first memory associated with the first processor and a second part of the data is stored in a second memory associated with the second processor;
calculating a first estimated time for the first processor to execute the processing request; and
calculating a second estimated time for the second processor to execute the processing request.

19. The method according to claim 18, wherein dispatching the processing request to the target includes dispatching the processing request to the first processor, the second processor, or to both the first processor and the second processor based at least in part on the first estimated time and the second estimated time.

20. The method according to claim 18, wherein:
calculating the first estimated time for the first processor to execute the processing request includes calculating a first transfer time to transfer the second part of the data to the first memory associated with the first processor; and
calculating a second estimated time for the second processor to execute the processing request includes calculating a second transfer time to transfer the first part of the data to the second memory associated with the second processor.
